(19) United States
(12) Patent Application Publication
(10) Pub. No.: US 2012/0122363 A1
(43) Pub. Date: May 17, 2012

(54) Additives for Highly Repellent Polymeric Surfaces

(75) Inventor: Jeffery R. Owens, Panama City, FL (US)

(73) Assignee: DEPARTMENT OF THE AIR FORCE

(21) Appl. No.: 13/297,681

(22) Filed: Nov. 16, 2011

Related U.S. Application Data
(60) Provisional application No. 61/414,161, filed on Nov. 16, 2010.

(51) Int. Cl. D03D 15/00; C09K 3/00; B29B 7/00; C08K 5/03; D04H 13/00; C08K 5/06; C08K 5/5425; C08K 5/541; C08K 5/54; B32B 5/16; B05D 3/10; C08K 5/02

(52) U.S. Cl. 442/181; 427/331; 106/2; 264/328.18; 524/264; 524/265; 524/81; 524/351; 524/352; 524/366; 428/323; 442/327; 428/402

(57) ABSTRACT

An additive for an ultraphobic polymeric composite is provided. The additive can have an aspect ratio of greater than about 15:1, and a surface free energy of less than about 20 J/m². In addition, no single dimension of the additive is greater than about 50 micrometers. Upon mixing with a polymeric material having a viscosity of less than about 3000 cP and a surface tension of greater than about 35 mN/m to form a polymeric composite, the additive can bloom to the air interface surface of the polymeric composite to form surface roughness and an ultraphobic surface on the polymeric material.

### CROSS REFERENCE TO RELATED APPLICATION

This application claims filing benefit of U.S. Provisional Patent Application Ser. No. 61/414,161 having a filing date of Nov. 16, 2010, which is incorporated herein by reference in its entirety.

### RIGHTS OF THE GOVERNMENT

The invention described herein may be manufactured and used by or for the Government of the United States for all governmental purposes without the payment of any royalty.

### BACKGROUND

Phobic or repellent surfaces are typically characterized by measuring contact angle hysteresis of several liquids having a range of surface tensions and calculating a surface free energy from these data. For smooth surfaces, such as polymer coated or painted surfaces, Young's equation is typically employed for this purpose. However, for rough surfaces, such as those found in textiles, the Wenzel or Cassie-Baxter equations are typically used. Young's equation and empirical data suggest that the maximum contact angle for most oils and other low surface tension liquids on coated surfaces is less than 90°, which denotes a philic property for the polymer to said liquid. For instance, the contact angle of n-hexadecane on polytetrafluoroethylene (Teflon®) is less than 90°, so Teflon® is considered to be philic to n-hexadecane. Omniphobic materials are materials that are phobic (contact angle greater than 90°) and resist wetting by most liquids, including both oils, alcohols, and water.

Attempts have been made to form ultraphobic surfaces. For instance, U.S. Pat. No. 6,299,981 to Azzopardi, et al. describes a substrate, the face of which has a geometry describing bumps-and-hollows thereon. The geometry is formed, entirely or partly, by relatively small-size objects which are grafted onto the substrate surface. U.S. Pat. No. 6,660,363 to Barthlott describes a surface including elevations and depressions wherein the distances between the elevations are in the range of from 5 to 200 μm, and the heights of the elevations are in the range of from 5 to 100 μm. The elevations can be formed by stamping or etching, or by gluing a powder of hydrophobic polymers on the surface. U.S. Pat. No. 5,674,592 to Clark, et al. describes a low energy surface that includes a nanostructured film coated with an organized molecular assembly on the surface such as a Langmuir-Blodgett film, a self-assembled monolayer, or an organic layer having a molecularly ordered surface. U.S. Published Patent Application No. 2010/028599 to Ulrich, et al. describes a method of producing an ultrahydrophobic surface, the method comprising providing a mixture of a low surface energy material and a sacrificial material, forming a layer from the mixture wherein the layer contains particles of the sacrificial material, treating the layer so as to destroy the particles of sacrificial material and generate a laterally continuous matrix of solid low surface energy material containing an array of depressions. U.S. Published Patent Application No. 2008/0268233 to Lawin, et al. describes a surface that includes a binder and small particles. The binder is crosslinked and serves to fix the particles on the surface or fix the particles to one another.

While the above describe advancements in the art, room for further improvement exists. For example, what is needed in the art is a facile, single step formation process that can provide an ultraphobic surface defining a nano/microscale roughness. Moreover, a polymeric material that is heterogeneous across the depth of the material, with higher concentration of nano/microscale particles at an ultraphobic surface would be of benefit, for instance by decreasing the total amount of additives needed to form the ultraphobic surface.

### SUMMARY

According to one embodiment, disclosed is an additive for an ultraphobic polymeric composite. The additive can have an aspect ratio of greater than about 15:1, and a surface free energy of less than about 20 J/m². In addition, no single dimension of the additive is greater than about 50 micrometers. Upon mixing with a polymeric material having a viscosity of less than about 3000 cP and a surface tension of greater than about 35 mN/m to form a polymeric composite, the additive can bloom to the air interface surface of the polymeric composite to form surface roughness and an ultraphobic surface on the polymeric material.

An additive can be formed of any suitable material, such as an inorganic oxide or nitride, a silicon-based material, a metal, a polymer, or carbon. In order to lower the surface free energy of the additive, the additive can include a compound at a surface thereof that includes at least one of silicon and fluorine.

Also disclosed are polymeric composites including the additives. The composite material can include the polymeric material and the additives, and, due to the blooming effect of the additives, the composite can include the additives in a heterogeneous distribution across the composite. For example, at least about 50% of the additives can be at least partially contained within about 10 nanometers of the outer surface of the polymeric composite. This surface of the composite can exhibit ultraphobic characteristics, and can have a surface free energy of less than about 20 J/m².

The polymeric composite material can be formed into any desired configuration. For instance, the material can be extruded or molded, as in a fiber formation process, or can be utilized to form a coating, for instance on an automobile, a marine vehicle, or an aircraft.

### BRIEF DESCRIPTION OF THE FIGURES

A full and enabling disclosure of the subject matter, including the best mode thereof, directed to one of ordinary skill in the art, is set forth more particularly in the remainder of the specification, which makes reference to the appended figures in which:

FIG. 1 illustrates a cross sectional view of an additive of indeterminate cross sectional shape, and an overlay shape for use in determining a width parameter as may be used in obtaining the aspect ratio of the additive.

FIG. 2 illustrates the wetting behavior of a variety of polymeric materials as described herein including polymeric materials with no additives, and polymeric materials modified with various different additives, including low surface energy, high aspect ratio additives.

FIG. 3 illustrates the corresponding surface free energy of the polymeric materials of FIG. 2 as calculated from the contact angle data of FIG. 2.

FIG. 4 illustrates the x-ray photoelectron spectroscopic (XPS) data of a variety of polymeric materials formulated with various low surface energy additives.

### DETAILED DESCRIPTION

Reference now will be made in detail to various embodiments of the disclosed subject matter, one or more examples of which are set forth below. Each example is provided by way of explanation, not limitation. In fact, it will be apparent to those skilled in the art that various modifications and variations may be made in the present disclosure without departing from the scope or spirit of the subject matter. For instance, features illustrated or described as part of one embodiment may be used on another embodiment to yield a still further embodiment. Thus, it is intended that the present disclosure covers such modifications and variations as come within the scope of the appended claims and their equivalents.

In general, disclosed herein are polymeric composites that include surface segregating additives that can instill omniphobic, highly repellent qualities to the polymer. More specifically, disclosed polymeric composite materials incorporate nano- and/or micro-sized materials as additives that describe both a high aspect ratio and a low surface free energy. The combination of the high aspect ratio and low surface free energy allows the additive to maintain mobility within the polymers, thus allowing the additives to bloom to the surface of the polymeric composite and create a nano/microscale roughness at the surface. The additives are of a size that following bloom to the surface, the surface can appear seemingly smooth, while exhibiting omniphobic qualities. As utilized herein, the term “bloom” is intended to refer to the migration of the additives to an energetically more favorable location within the composite, with no energy added to the system to encourage the migration of the additives.

The micro- and/or nano-sized additives can generally have an aspect ratio of greater than about 15:1, for instance greater than about 30:1. As utilized herein, the term aspect ratio is intended to refer to the ratio of the length of a structure to a cross sectional width of the structure. For instance, when considering a cylindrical additive, the aspect ratio is the ratio of the length to the cross sectional diameter of the structure. However, disclosed additives are not limited to any particular cross sectional shape. For instance, an additive can have a round, square, ovoid, triangular, or undefined cross sectional shape.

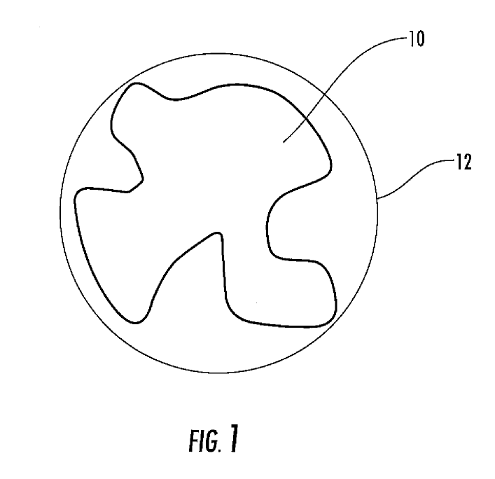

The cross sectional shape of an additive can vary over the length of the additive. For example, an additive can describe a cone or pyramidal shape, in which case the cross sectional width for use in determining the aspect ratio can be the average cross sectional width as measured along the length of the additive. An additive can have a branched or dendritic morphology. According to this embodiment, the aspect ratio of the additive can be determined according to the geometry of an enveloping shape that encompasses the irregularly shaped additive. When considering an additive of indeterminate cross sectional shape, for instance an additive including depressions at the surface of the additive, an embodiment of which is illustrated in FIG. 1 at 10, the cross sectional shape can be determined by the diameter or cross sectional width of a regular shape 12, in this particular case, the radius of a circle, that can encompass the entire irregular shaped additive 10.

The high aspect ratio additives can be formed on a nano- or micro-scale. Thus, upon blooming to the surface of the polymeric composite, the additives can form surface roughness on a micro- or nano-scale that can create an ultraphobic surface. For instance, an additive can have a largest dimension of up to about 50 μm, or up to about 30 μm in another embodiment. For example, in one embodiment, the largest dimension of the additive can be less than about 5 μm. By way of example, additive shapes can include nanofibers, nanotubes, and nanowires of a length of up to about 50 μm and a cross sectional width of less than about 100 nm, for instance less than about 50 nm.

In addition to a high aspect ratio, additives can have a surface free energy of less than about 20 J/m². Methods for determining the surface free energy of a nano- or micro-particle are generally known to those of skill in the art, any of which may be utilized in determining the surface free energy of the high aspect ratio additives. For example, methods based on imbibitions of probe liquids into a thin porous layer or column including the additives can be utilized as described by Chibowski, et al. (Journal of Colloid and Interface Science, 240:2, 2001, 473-479). In another embodiment, the contact angle of a liquid (e.g., water) can be observed on the material of the additive and the surface free energy can be estimated from the Fowkes approximation. Another method relies on the determination of the adsorption isotherm of a liquid or vapor over the additive materials. From this isotherm the film pressure, π, can be calculated. Based on the π value, the surface free energy component of the mineral can be estimated (see, e.g., Chibowski, et al., Clay and Clay Minerals, 1988, p. 455).

Additives can be formed of any suitable materials, either organic or inorganic, provided the additives are high aspect ratio, low surface free energy materials as described herein. For instance, additives can be formed of inorganic oxides or nitrides including, without limitation, aluminum oxide, titanium oxide, zirconium oxide, nickel oxide, iron oxide, gallium nitride, boron nitride, indium nitride, iron nitride, and the like. In one embodiment, silicon-based materials such as silicone particles, silica particles, polysiloxane particles, and/or silicon nitride, can be utilized. Metal particles can be used such as gold, silver, nickel, and alloys of metals. Polymeric particles can be used, such as polystyrene particles, (meth)acrylates particles, PTFE particles, polyolefin particles, polycarbonate particles, polyhedral oligomeric silicates, polyester particles, polyamide particles, polyurethane particles, ethylenically unsaturated polymer particles, polyanhydride particles and biodegradable polymeric particles such as polycaprolactone (PCL) and polylactideglycolide (PLGA). Particles formed of carbon can be utilized such as, without limitation, carbon nanotubes, graphite particles, nanodiamonds, and the like. In addition, mixtures of additives can be utilized, including additives of different materials, sizes, and shapes.

Micro- and nano-sized particles can be purchased on the retail market or formed according to known processes. For instance, a variety of different types of nanoparticles having high aspect ratios can be formed according to chemical vapor deposition (CVD) methods as are generally known in the art, examples of which are described in U.S. Pat. Nos. 7,754,183 and 7,241,479 to Rao, et al, which are incorporated herein by reference.

Metal-based particles such as metal oxide and metal nitride particles may be made by plasma synthesis. In plasma reaction, in a high vacuum flow reactor, a metal rod or wire is irradiated to produce intense heating creating plasma-like conditions. Metal atoms are boiled off and carried downstream where they are quenched and quickly cooled by a reactant gas, most notably oxygen or nitrogen, to produce nano-sized metal oxide or metal nitride particles. Particle properties (e.g., aspect ratio) and size can be controlled by the temperature profiles in the reactor as well as the concentration of the quench gas.

Laser ablation and electric arc discharge methods as are generally known can be utilized in forming the high aspect ratio additives, such as carbon nanotubes and the like.

High aspect ratio metal structures can be formed according to standard formation methods, including electrolytic methods, chemical reduction methods and photo-reduction methods as are conventionally known. One example of an electrolytic method has been described by Yu, et al. (J. Phys. Chem. B, 101, 6661 (1997)). Other methods have been described by Niidome, et al. in U.S. Pat. No. 7,691,176, which is incorporated herein by reference.

Polymeric micro- and nano-structures have been described that can define a high aspect ratio. For instance, nanoporous templates have been used for the fabrication of high aspect ratio nanostructured materials. Both track-etched polymer membrane and anodized aluminum oxide (AAO) membrane have been widely used to prepare polymer nanotubes and nanowires.

Depending upon the nature of the material forming the high aspect ratio additives, it may be necessary to further treat the additives, for instance in order to provide the additives with the desired surface free energy of less than about 20 J/m². For example, additives may be chemically treated to lower the surface free energy of the additive.

According to one embodiment, an additive may be surface treated with one or more compounds to decrease the surface free energy of the additive. The surface treatment method can include functionalization of the particle surface with a compound, for instance a fluorine or silicon-containing compound, so as to decrease the surface free energy of the additive. Functionalization methods can include direct grafting, plasma treatment, microwave treatment, and the like. Methods as are known in the art can be utilized, such as those described in U.S. Pat. No. 7,081,234 to Qi, et al.

In one embodiment, additives may be surface treated to include silicon-containing compounds according to methods described in U.S. Published Patent Application 2010/0239784 to Owens, which is incorporated herein by reference. According to this method, one or more silicon-containing compounds can contact the surface of the additives and the compounds and surface can be exposed to electromagnetic radiation having a frequency from 0.3 to 30 GHz, which can encourage bonding between the silicon-containing compounds and the surface of the additives.

Another exemplary surface treatment process as may be utilized to decrease the surface free energy of an additive will be described. Initially, a mixture can be formed of the additive particles, for example metal oxide or metal nitride particles, a solvent, and a surface treatment agent. Any solvent may be used, though in one embodiment a non-polar solvent may be preferred, for instance a high boiling point inert non-polar solvent. Examples of suitable solvents include dodecane, hexadecane, tridecane, ISOPAR (isoparaffinic hydrocarbons), toluene, xylene, chlorobenzene, dichlorobenzene, mixtures thereof, and the like.

As the surface treatment agent, agents such as silanes, siloxanes, and fluorines may be used, including organochlorosilanes, organofluorines, organosilane ethers or their titanium analogs.

In one embodiment, the surface treatment agents can have a structure represented by the formula of

R—Z(X)ₙY₃₋ₙ

wherein R and X each independently represent an alkyl group, an aryl group, a substituted alkyl group or a substituted aryl group, an organic group containing carbon-carbon double bond, carbon-carbon triple bond, or epoxy group,

Z represents a silicon atom or a fluorine atom,

Y represents a hydrogen atom, a halogen atom, a hydroxyl group, an alkoxy group, and an allyl group, and

n is an integer of from 0 to 3.

Examples of R and X can include alkyl groups containing from about 1 carbon atom to about 30 carbon atoms such as methyl, ethyl, propyl, iso-propyl, butyl, sec-butyl, tert-butyl, pentyl, hexyl, heptyl, octyl, dodecyl, cyclohexyl and the like; halogen substituted alkyl groups containing from about 1 to about 30 carbon atoms such as chloromethylene, trifluoropropyl, tridecafluoro-1,1,2,2-tetrahydrooctyl and the like. R may comprise aryl groups containing from about 6 to about 60 carbon atoms such as phenyl, alkylphenyl, biphenyl, benzyl, phenylethyl, and the like; halogen substituted aryl groups containing from about 6 to about 60 carbon atoms such as chlorophenyl, fluorophenyl, perfluorophenyl and the like; hydroxyl substituted aryl groups containing from about 6 to about 60 carbon atoms such as phenol, naphthol, cresol, binaphthal and the like; alkyl substituted aryl groups of from about 7 to about 60 carbon atoms such as methyl, ethyl, propyl, and the like; aryl groups containing nitrogen atoms such as cyanide substituted aryl and amino substituted aryl groups, and five or six membered aromatic groups containing nitrogen atom(s); an organic group containing carbon-carbon double bond(s) of from about 1 to about 30 carbon atoms, such as γ-acryloxypropyl group, γ-methacryloxypropyl group and vinyl group; an organic group containing carbon-carbon triple bond(s) of from about 1 to about 30 carbon atoms, such as acetylenyl and the like; an organic group containing epoxy group such γ-glycidoxypropyl group and β-(3,4-epoxycyclohexyl)ethyl group and the like.

Typical examples of Y can include a hydrogen atom, a halogen atom such as chlorine, bromine, and fluorine; a hydroxyl group; an alkoxy group such as methoxy, ethoxy, iso-propoxy and the like; and an allyl group.

Specific examples of surface treatment agents can include, without limitation, methyltrimethoxysilane, ethyltrimethoxysilane, methyltriethoxysilane, propyltrimethoxysilane, octyltrimethyoxysilane, trifluoropropyltrimethoxysilane, tridecafluoro-1,1,2,2-tetrahydrooctyltrimethoxysilane, p-tolyltrimethoxysilane, phenyltrimethoxysilane, phenylethyltrimethoxysilane, benzyltrimethoxysilane, diphenyldimethoxysilane, dimethyldimethoxysilane, bromophenylsilane, cyanophenylsilane, fluorophenylsilane, diphenyldisilanol, cyclohexylmethyldimethoxysilane, vinyl trimethoxysilane, 3-glycidoxyproplytrimethoxy-silane, 3-(trimethoxysilyl)propylmethacrylate, and mixtures thereof.

The additive particles, solvent and surface treatment agent may be subjected to any suitable mixing to form a well-dispersed mixture. By way of example, the mixing may be conducted by sonication. Any suitable and/or commercially available sonication equipment may be used without limitation. The sonication can be conducted for a suitable length of time, for example from about 1 minute to about 120 minutes per 10 grams particles, or from about 10 minutes to about 60 minutes per 10 grams particles. The amount of surface treatment agent in the mixture may be from about 1 to about 50 weight percent to the amount of particles in the mixture, preferably from about 3 to about 25 weight percent to the amount of particles.

During, following, or both during and following mixing, the mixture can be heated to a temperature of at least about 80° C., for instance from about 100° C. to about 250° C., or from about 100° C. to about 220° C., for a period of time, generally at least 1 hour, for instance from about 1 to about 24 hours, or from about 3 hours to about 14 hours. The higher temperature allows reaction and bonding of the surface treatment agent to the particle surface.

The preferred surface treatment agent and/or process can depend upon the material used to form the additive particles. For instance metals, such as gold, silver, and other noble metals and alloys can be surface treated with alkylthiols, and in one particular embodiment, fluoroalkylthiols, so as to lower the surface free energy of the additive particles. According to one such process, self-assembled monolayers (SAM) of a fluoroalkyl thiol, e.g., a perfluoroalkyl amide ethanethiol, F(CF₂)ₙCONH(CH₂)₂SH (n=6, 7, or 8), can be utilized to surface treat a metal additive particle.

Such fluorinated thiols can be synthesized by reacting fluoroalkyl acid chloride with 2-aminoethanethiol, or by reacting methyl fluoroalkanoate with 2-aminoethanethiol. SAM can then be formed by immersing the metal particles in solutions of the fluorinated amidethiol in propanol (e.g., 1 wt % solutions).

According to another embodiment, cotelomers containing fluoro- and silane groups can be grafted to additive particles, for instance to silica particles. According to this embodiment, free-radical cotelomerization of 3-(trimethoxysilyl)propyl methacrylate (TMSPMA) with 1,1,2,2-tetrahydroperfluorodecyl acrylate (PFDA) can be carried out in the presence of 2-mercaptoethanol at 80° C. in acetonitrile. Hydroxy end-groups of the cotelomers can then be reacted with 2-isocyanatoethyl methacrylate to give macromonomers. The P(TMSPMA-stat-PFDA) cotelomers, containing fluoro and silane groups, can then be grafted onto the additive particles, for instance in toluene at about 110° C. (see, e.g., Pardal, et al. Journal of Polymer Science Part A: Polymer Chemistry, 47:18, 4617-4628, 15 Sep. 2009).

Additives can be directly surface treated with fluorine to decrease the surface free energy of the materials. For instance, carbon additives, such as carbon nanotubes, can be fluorinated with fluorine gas (F₂) at 250° C., according to known methods.

High energy plasma and microwave treatments can also be used to surface treat the nano- or micro-sized additive particles and lower the free surface energy. For example, plasma treatment of CVD formed additive materials can be carried out utilizing CF₄ plasma in an inductive RF plasma chamber.

The low free surface energy, high aspect ratio additives can be combined with a polymeric material in forming an ultraphobic polymeric surface. The polymer resin of the composite material can have a viscosity that will not prevent the additives from blooming to the surface of the polymeric material following combination of the two and prior to final set of the polymer. For instance, in order to encourage blooming of the high aspect ratio, low surface free energy additives to the surface of the composite, the polymeric resin can have a viscosity of up to about 3000 cP, and a surface tension of greater than about 35 mN/m.

The preferred characteristics of any system can depend upon the characteristics of the specific polymer resin used and the additives to be combined with the resin. For instance, if relatively large additives are utilized, e.g., one or more of the dimensions of the blooming additive exceeds about 1 μm, then the value of the surface tension of the polymer resin as measured in mN/m can be greater than about four times the value of the surface energy of the additive as measured in J/m², assuming a viscosity of about 3000 cP and a cure time of greater than about 1 hour for the polymer resin system, and the additives can bloom to the surface of the polymer during the polymer cure. For instance, given a system including relatively large additives, a viscosity of the polymer resin of about 3000 cP, and a cure time for the polymer of more than about an hour, if the surface tension of the polymer resin is 35 mN/m, then the surface energy of the additive can be less than 8.75 J/m², i.e., less than about ¼ of the value.

In forming the polymeric material, the polymer may be combined with any additives as are generally known in the art. For instance, diluents and the like can be combined with the polymer to form a polymer resin meeting the desired specifications to encourage bloom of the additives during polymer cure.

If a faster cure time is desired, for instance less than about 1 hr, then the parameters of the system can be adjusted accordingly. For instance, smaller additives can be utilized and all dimensions of the blooming additive can be less than about 1 μm. Smaller additives can bloom more quickly, and thus the faster cure time of the polymer will not hinder blooming of the additives to the surface. Additionally, the viscosity of the polymer resin can be less to encourage faster bloom. For instance, the viscosity of a polymer resin can be less than about 1500 cP when utilizing a polymer resin system that cures in less than one hour. The ratio of the value of the surface tension of the polymer resin in mN/m to the value of the surface tension of the solvent/polymer in J/m² can stay the same or can differ from that of a slower curing system. For example, the value of the surface tension of the polymer resin in mN/m can be greater than about 4 times the value of the surface energy of the additive in J/m².

In general, in order for the additives to bloom the value of the surface tension of the polymer resin as provided in mN/m can be at least about two times the value of the surface energy of the additive as provided in J/m². As polymer resin viscosity increases, the necessary cure time of the polymer resin will also increase, so as to ensure the desired bloom of additives prior to complete cure of the polymer. The determination of preferred values for each parameter in any given system are well within the skills of one of the art.

The polymer of the polymeric material is not limited to any particular polymer. For instance, a polymeric material can include one or more of polyurethanes, polyolefins (e.g., polyethylene, polypropylene), polyaramids, polyamides (e.g., nylon), polybenzooxazoles, polyureas, polyesters, viscose (e.g., rayon), polyacrylates, polyacrylamides, latex, silicone polymers, polyphthalates, polyoxazoles, polyimidazoles, fluorinated polymers (e.g., polyfluoroethylenes), polystyrenes, polynitriles, polyacrylonitriles, polyvinylidenes, polyvinyls (e.g., polyvinyl chloride), natural or synthetic rubbers (e.g., polyisoprene, polybutadiene).

Other additives that can be incorporated in the polymeric material can include, without limitation, coloring agents, such as dyes or other pigments, nucleating agents, anti-static agents, antioxidant agents, antimicrobial agents, adhesion agents, stabilizers, plasticizers, brightening compounds, clarifying agents, ultraviolet light stabilizing agents, surface active agents, odor enhancing or preventative agents, light scattering agents, halogen scavengers, and the like.

A composite including the polymeric material and the high aspect ratio, low surface free energy additives can be formed according to any suitable process. For instance, the composite materials may be melt mixed or solution mixed. In one embodiment, the components can be mixed according to a high energy or high shear mixing process.

The components of the composite can be combined in any suitable order. For example, in one embodiment, a polymeric resin including the polymer(s) and traditional additives such as dyes, stabilizing agents, and the like can be formed. Following, the polymeric resin can be combined with the high aspect ratio, low surface free energy additives. The high aspect ratio, low surface free energy additives can be included in the composite material in an amount between about 0.2 wt. % to about 70.0 wt. % by weight of the composite material, for instance between about 0.5 wt. % and about 10 wt. %, or between about 1 wt. % and about 5 wt. %.

Following mixing, the composite material can be formed and configured as desired to a final application. For instance, the material can be molded or otherwise shaped to a desired configuration. The preferred molding or shaping process can depend upon the specific characteristics of the composite material, for instance, the viscosity of the composite material. By way of example, in one embodiment, a composite material can be melt extruded to form filaments, fibers, or multifilament yarns, for instance as may be used in forming a woven or nonwoven web.

In another embodiment, a composite material can be injection molded, blow molded, or the like to form a final configuration. For example, a composite material can be injection blow molded, extrusion blow molded, or stretch blow molded according to known processing techniques.

In yet another embodiment, the composite material can be utilized as a coating material. For example, the composite material can have a relatively low viscosity following formation, and the formed composite material can be utilized as a coating layer on a substrate surface. A composite material for use as a coating can be applied according to any suitable method, including, without limitation, spin coating, printing, painting, dip coating, spray coating, and the like. When utilizing the composite material in a coating application, it may be beneficial to apply the coating relatively quickly following mixing of the composite material, so as to ensure that the additives are homogeneously distributed throughout the composite material during application of the composite material to the desired substrate.

Following formation of the composite material, as in a molding process, or application of the composite material to a substrate in a coating process, the high aspect ratio, low surface free energy additives can bloom to the surface of the composite. More specifically, the additives will bloom to the air interface of the composite material during cure of the polymer of the composite.

As the additives bloom to the surface (i.e., the air interface surface) of the composite material, the surface will obtain increased roughness. However, because the additives are formed on a micro- or nano-scale, the surface will remain smooth on a macroscopic scale. In addition of the surface roughness leads to the formation of omniphobic characteristics at the surface. In general, the surface of the composite material, following blooming of the additives to the surface, can have a surface free energy of less than about 20 J/m², for instance less than about 15 J/m², or less than about 10 J/m².

Following bloom, the composite material can have a heterogeneous distribution of the high aspect ratio, low surface energy additives, with the bulk of the additives being at or near the surface of the composite material. For instance, more than 50 wt. % of the high aspect ratio, low surface free energy additives can be at least partially contained within about 10 nm of the air interface surface. In one embodiment, more than 60% of the additives can be at least partially contained within about 10 nm of the surface, for instance between about 60% and about 70% of the additives can be within about 10 nm of the surface. This can be of benefit in forming an ultraphobic surface, as the heterogeneous distribution of the additives across the composite material can allow for a lower total concentration of additives can be utilized, while still obtaining a high additive concentration and the ultraphobic characteristics at the surface of the material.

An ultraphobic surface can resist adhesion of solids as well as absorption of liquids, and in one embodiment, both aqueous and organic liquids. In addition, the ultraphobic surfaces can be easy to clean, and dirt, chemicals, fluids, or other materials can be removed from the surfaces, without absorbance or adherence to the surface. Moreover, disclosed composite materials can resist absorbance of compounds, for instance poisonous or other dangerous compounds, e.g., chemical warfare agents.

An ultraphobic surface can reduce friction at the ultraphobic surface, and in one particular embodiment can reduce skin friction at the ultraphobic surface. Accordingly, disclosed polymeric surfaces can be beneficially utilized in coatings in transportation applications including coatings on automobiles, marine vehicles, and aircraft.

When utilized in textile applications, either as fibrous polymeric composite materials or as coatings, disclosed materials can provide dirt and oil resistant textiles.

The present disclosure can be further understood with reference to the Examples, below.

### EXAMPLE 1

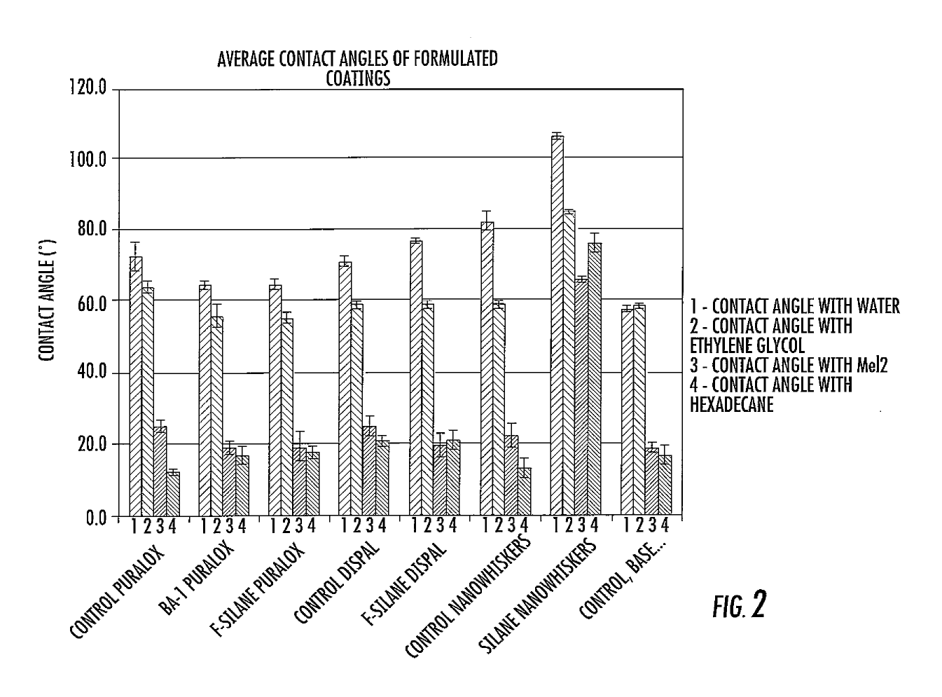

FIG. 2 illustrates the wetting behavior of coatings including
1. Unmodified coatings formed as a control
2. Coatings modified with various additives not having high-aspect-ratios
3. Coatings modified with various low-surface-energy additives not having high-aspect-ratios, and
4. A coating modified with a low-surface-energy, high-aspect-ratio additive.

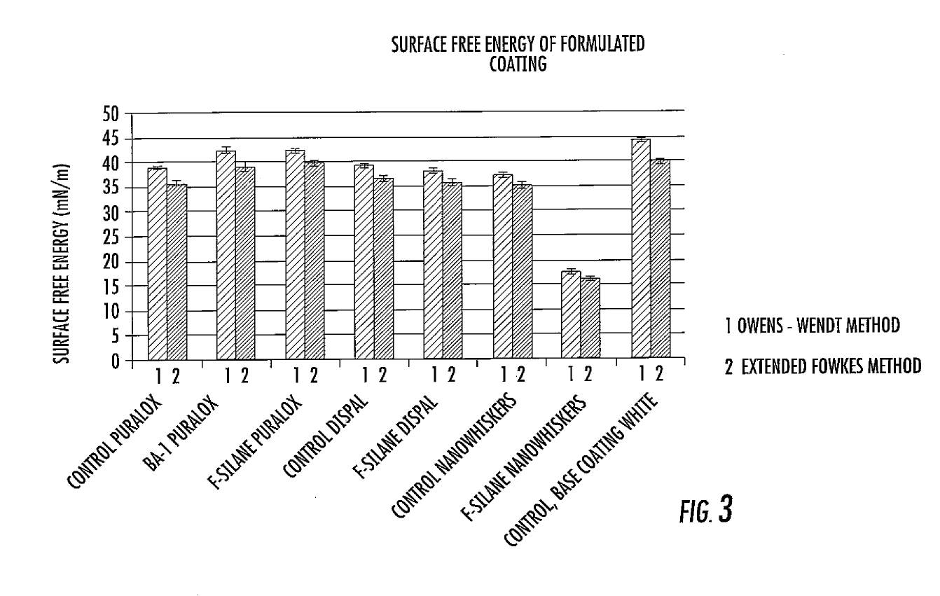

FIG. 3 shows the corresponding surface-free-energy of these coatings, as calculated from the contact angle data according to both the Owens-Wendt Method and the Extended Fowkes Method.

### EXAMPLE 2

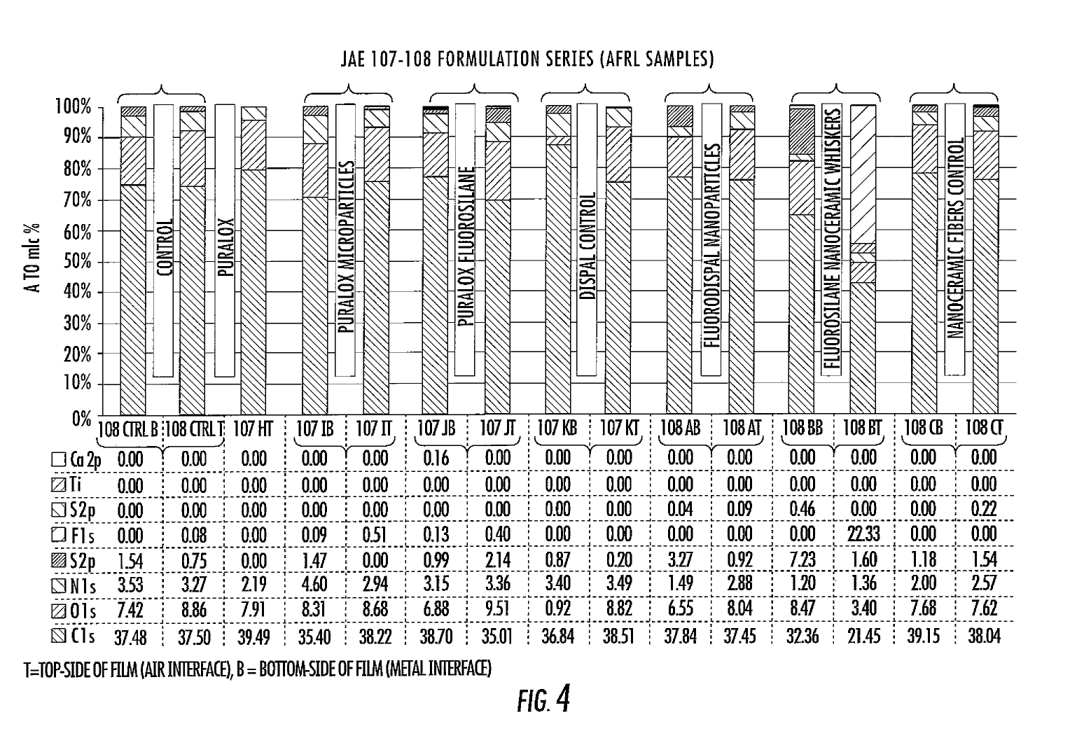

FIG. 4 shows the x-ray photoelectron spectroscopic (XPS) data of coatings formulated with various low-surface-energy additives. Sample 108B, the only sample containing high-aspect-ratio, low-surface-free-energy additive (fluorinated nanowhiskers) is also the only sample with a very high fluorine concentration at the surface. Note that the fluorine concentration on the backside of sample 108B does not contain significant amounts of fluorine, indicating that the additive surface segregated within the coating.

While the subject matter has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present disclosure should be assessed as that of the appended claims and any equivalents thereto

What is claimed is:

1. An additive for an ultraphobic polymeric composite, the additive comprising an aspect ratio of greater than about 15:1, the additive having a surface free energy of less than about 20 J/m², wherein no single dimension of the additive is greater than about 50 μm, the additive blooming to the air interface surface of a polymeric material having a viscosity of less than about 3000 cP and a surface tension of greater than about 35 mN/m to form surface roughness and an ultraphobic surface on the polymeric material.

2. The additive according to claim 1, wherein the additive has an aspect ratio of greater than about 30:1.

3. The additive according to claim 1, wherein the additive has a surface free energy of less than about 15 J/m².

4. The additive according to claim 1, wherein no single dimension of the additive is greater than about 5 μm.

5. The additive according to claim 1, wherein the additive is formed of an inorganic oxide or nitride, a silicon-based material, a metal, a polymer, or carbon.

6. The additive according to claim 1, the additive further comprising a compound at a surface of the additive that includes at least one of silicon and fluorine.

7. The additive according to claim 6, wherein the compound at the surface of the additive has a structure represented by the formula:
R—Z(X)ₙY₃₋ₙ
wherein R and X each independently represent an alkyl group, an aryl group, a substituted alkyl group or a substituted aryl group, an organic group containing carbon-carbon double bond, carbon-carbon triple bond, or epoxy group,
Z represents a silicon atom or a fluorine atom,
Y represents a hydrogen atom, a halogen atom, a hydroxyl group, an alkoxy group, and an allyl group, and
n is an integer of from 0 to 3.

8. A polymeric composite comprising:
a polymeric material; and
additives within the polymeric material, the additives comprising an aspect ratio of greater than about 15:1, the additives having a surface free energy of less than about 20 J/m², wherein no single dimension of the additives is greater than about 50 μm;
the polymeric composite defining an outer surface at an air interface, wherein at least about 50% of the additives are at least partially contained within about 10 nm of the outer surface of the polymeric composite, the polymeric composite outer surface having a surface free energy of less than about 20 J/m².

9. The polymeric composite according to claim 8, wherein the polymeric composite includes the additives in an amount of between about 0.2 wt. % and about 70 wt. % of the polymeric composite.

10. The polymeric composite according to claim 8, wherein the polymer is selected from the group consisting of polyurethanes, polyolefins, polyaramids, polyamides, polybenzooxazoles, polyureas, polyesters, viscose, polyacrylates, polyacrylamides, latex, silicone polymers, polyphthalates, polyoxazoles, polyimidazoles, fluorinated polymers, polystyrenes, polynitriles, polyacrylonitriles, polyvinylidenes, polyvinyls, natural or synthetic rubbers, and combinations thereof.

11. The polymeric composite according to claim 8, wherein the polymeric composite is a fiber.

12. The polymeric composite according to claim 11, wherein the fiber is a portion of a woven or nonwoven web.

13. The polymeric composite according to claim 8, wherein the polymeric composite is a coating.

14. The polymeric composite according to claim 13, wherein the coating is a coating on an automobile, a marine vehicle, or an aircraft.

15. A method of forming an ultraphobic surface comprising:
combining a polymeric material with additives to create a mixture, the polymeric material having a viscosity of less than about 3000 cP and a surface tension of greater than about 35 mN/m, the additives comprising an aspect ratio of greater than about 15:1, the additives having a surface free energy of less than about 20 J/m², wherein no single dimension of the additives is greater than about 50 μm, wherein the surface tension of the polymeric material as provided in mN/m is at least about two times the value of the surface energy of the additive as provided in J/m²; and
forming the mixture to a desired configuration; wherein
subsequent to forming the mixture the desired configuration, the additives bloom to an outer surface of the configuration such that at least about 50% of the additives are within about 10 nm of the outer surface of the configuration, the outer surface of the configuration being at an air interface.

16. The method according to claim 15, wherein the polymeric material and the additives are combined according to a high energy mixing process.

17. The method according to claim 15, wherein the step of forming the mixture to the desired configuration comprises molding the mixture.

18. The method according to claim 17, wherein the mixture is molded according to an extrusion molding process.

19. The method according to claim 17, wherein the mixture is molded according to an injection molding process.

20. The method according to claim 15, wherein the step of forming the mixture to the desired configuration comprises coating the mixture on a substrate.

21. The method according to claim 20, wherein the mixture is coated on a surface of an automobile, a marine vehicle, or an aircraft.
